(19) United States
(12) Patent Application Publication
(10) Pub. No.: US 2022/0253053 A1
(43) Pub. Date: Aug. 11, 2022

(54) REMOTE OPERATING SYSTEM AND REMOTE OPERATING METHOD

(71) Applicant: TOYOTA JIDOSHA KABUSHIKI KAISHA, Toyota-shi Aichi-ken (JP)

(72) Inventors: Satoru Niwa, Sunto-gun Shizuoka-ken (JP); Toru Takashima, Susono-shi Shizuoka-ken (JP); Takashi Suzuki, Susono-shi Shizuoka-ken (JP); Rio Suda, Toyota-shi Aichi-ken (JP); Hiromitsu Urano, Numazu-shi Shizuoka-ken (JP); Sho Otaki, Yokohama-shi Kanagawa-ken (JP); Hiromitsu Kobayashi, Nisshin-shi Aichi-ken (JP); Hojung Jung, Sunto-gun Shizuoka-ken (JP); Kosuke Akatsuka, Mishima-shi Shizuoka-ken (JP)

(73) Assignee: TOYOTA JIDOSHA KABUSHIKI KAISHA, Toyota-shi Aichi-ken (JP)

(21) Appl. No.: 17/665,061

(22) Filed: Feb. 4, 2022

(30) Foreign Application Priority Data
Feb. 9, 2021 (JP) 2021-019031

(51) Int. Cl. G05D 1/00; B60W 60/00; B60W 10/20

(52) U.S. Cl. CPC G05D 1/0016; B60W 60/001; B60W 60/0053; B60W 2540/18; G05D 2201/0213; B60W 2510/202; B60W 10/20

(57) ABSTRACT

A remote operating system is equipped with an automatically operated vehicle and a remote operating device. A first processor of the automatically operated vehicle calculates a target steering angle of a first steering unit on the vehicle side during the performance of automatic operation control. A first communication device transmits the target steering angle to the remote operating device. A second processor on the remote operating device side controls an electric motor in such a manner as to generate a driving torque for making a steering angle of a second steering unit coincident with the target steering angle, during the execution of a cooperative mode in which a turning actuator on the vehicle side is controlled through cooperation between remote operation control for controlling the turning actuator based on the steering angle of the second steering unit steered by an operator and the automatic operation control.

### CROSS-REFERENCE TO RELATED APPLICATION

This application claims priority to Japanese Patent Application No. 2021-019031 filed on Feb. 9, 2021, incorporated herein by reference in its entirety.

### BACKGROUND

### 1. Technical Field

The present disclosure relates to a remote operating system and a remote operating method for a vehicle.

### 2. Description of Related Art

In Japanese Unexamined Patent Application Publication No. 2019-174993 (JP 2019-174993 A), there is disclosed an information processing device that is equipped with a control unit for controlling a remote operating device that performs remote operation of a remotely operated vehicle. This control unit makes a steering angle of a steering unit on the remote operating device side coincident with an actual steering angle of a steering unit of the remotely operated vehicle (an example of information on a state of remotely operated equipment in indicating a physical state of equipment of the remotely operated vehicle), in starting remote operation of the remotely operated vehicle. In concrete terms, when the steering angle of the steering unit on the remote operating device side does not coincide with the actual steering angle of the steering unit of the remotely operated vehicle, a warning issuance unit of the information processing device transmits warning information including an amount and a direction of rotation of a steering wheel that are needed to make the steering angles of the steering units coincident with each other.

### SUMMARY

In remotely manipulating the automatically operated vehicle by the remote operating device, it is conceivable to control a steering device (turning actuator) of the automatically operated vehicle through cooperation between automatic operation control and remote operation control. During the execution of such a cooperative mode, an operator who manipulates the steering unit of the remote operating device is desired to be able to grasp a manipulation amount of the steering device according to automatic operation control (a steering angle of the steering unit on the vehicle side).

In order to grasp the aforementioned manipulation amount, it is conceivable to drive the steering unit of the remote operating device through the use of an electric motor, such that the steering angle of the steering unit of the remote operating device coincides with the actual steering angle of the steering unit of the automatically operated vehicle (the remotely operated vehicle), during the execution of the cooperative mode. However, the steering unit on the vehicle side may vibrate due to road surface disturbance. Therefore, when the actual steering angle is used, vibrations are reflected on the steering unit of the remote operating device as well. As a result, the operator may find it difficult to sensuously grasp the steering angle at which the steering device is about to be controlled through automatic operation control.

The present disclosure has been achieved in consideration of the problem as described above, and aims at making it possible for the operator who carries out remote manipulation to grasp the steering angle of the steering unit on the vehicle side according to automatic operation control during the execution of the cooperative mode, without being affected by vibrations resulting from road surface disturbance.

A remote operating system according to the present disclosure is equipped with an automatically operated vehicle and a remote operating device that remotely manipulates the automatically operated vehicle. The automatically operated vehicle includes a steering device, a first processor, and a first communication device. The steering device includes a first steering unit, and a turning actuator that turns a wheel of the automatically operated vehicle. The first processor performs automatic operation control, and calculates a target steering angle of the first steering unit during the performance of the automatic operation control. The first communication device transmits the target steering angle to the remote operating device. The remote operating device includes a second steering unit, an electric motor, a second communication device, and a second processor. The second steering unit is manipulated by an operator for remote manipulation of the steering device. The electric motor rotationally drives the second steering unit. The second communication device receives the target steering angle from the first communication device, and transmits a steering angle of the second steering unit to the first communication device. The second processor controls the electric motor in such a manner as to generate a driving torque for making the steering angle of the second steering unit coincident with the target steering angle, during the execution of a cooperative mode in which the turning actuator is controlled through cooperation between remote operation control for controlling the turning actuator based on the steering angle of the second steering unit steered by the operator and the automatic operation control. The turning actuator is controlled based on the steering angle of the second steering unit that is transmitted from the second communication device, during the execution of the cooperative mode.

The cooperative mode may be executed when manipulation of the steering device according to the automatic operation control is overridden by manipulation according to the remote operation control.

The cooperative mode may be ended when an override completion condition is fulfilled. Moreover, the override completion condition may be fulfilled when a state where a steering force exerted by the operator is applied to the second steering unit and a difference between the steering angle of the second steering unit and the target steering angle is smaller than a threshold has lasted for a predetermined time.

The second processor may control the electric motor such that the driving torque gradually decreases, after fulfillment of an override completion condition that is fulfilled when a state where the steering force exerted by the operator is applied to the second steering unit and a difference between the steering angle of the second steering unit and the target steering angle is smaller than a threshold has lasted for a predetermined time.

The cooperative mode may be executed when steering assist of the automatically operated vehicle through the automatic operation control is carried out during the performance of the remote operation control.

The second processor may control the electric motor such that the steering angle of the second steering unit coincides with an actual steering angle of the first steering unit, in a case where manipulation of the steering device through the automatic operation control is overridden by the remote operation control when an abnormality occurs in calculation of the target steering angle by the first processor.

A remote operating method according to the present disclosure is designed to remotely manipulate an automatically operated vehicle by a remote operating device. The automatically operated vehicle includes a steering device including a first steering unit and a turning actuator that turns a wheel of the automatically operated vehicle. The remote operating device includes a second steering unit that is manipulated by an operator for remote manipulation of the steering device, and an electric motor that rotationally drives the second steering unit. The remote operating method includes calculating a target steering angle of the first steering unit during the performance of automatic operation control of the automatically operated vehicle, controlling the electric motor in such a manner as to generate a driving torque for making the steering angle of the second steering unit coincident with the target steering angle, during the execution of a cooperative mode in which the turning actuator is controlled through cooperation between remote operation control for controlling the turning actuator based on the steering angle of the second steering unit steered by the operator and the automatic operation control, and controlling the turning actuator based on the steering angle of the second steering unit that is transmitted from the remote operating device to the automatically operated vehicle, during the execution of the cooperative mode.

With the remote operating system and the remote operating method according to the present disclosure, the electric motor is controlled in such a manner as to generate the driving torque for making the steering angle of the second steering unit on the remote operating device side coincident with the target steering angle of the first steering unit on the automatically operated vehicle side according to the automatic operation control, during the execution of the cooperative mode of the remote operation control and the automatic operation control. Since the target steering angle is used, the second steering unit does not synchronize with the actual steering angle of the first steering unit that vibrates due to road surface disturbance. Therefore, the operator who carries out remote manipulation can grasp the steering angle of the first steering unit on the automatically operated vehicle side according to the automatic operation control during the execution of the cooperative mode, without being affected by vibrations resulting from road surface disturbance.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram showing a configuration example of a remote operating system according to the first embodiment;

FIG. 2 is a view showing a concrete configuration example around a steering unit shown in FIG. 1;

FIG. 3 is a time chart for illustrating steering control at the time when remote operation overrides automatic operation;

FIG. 4 is a flowchart showing an example of the flow of a process regarding steering control according to the first embodiment;

FIG. 5 is a time chart for illustrating another example of steering control at the time when remote operation overrides automatic operation;

FIG. 6 is a flowchart showing an example of the flow of a process regarding another example of a cooperative mode according to the present disclosure; and

FIG. 7 is a flowchart showing an example of the flow of a process regarding steering control at the time of the occurrence of an abnormality according to the second embodiment.

### DETAILED DESCRIPTION OF EMBODIMENTS

In the case where numerical values such as the number, quantity, amount and range of respective elements are mentioned in the following embodiments, the present disclosure is not limited to the numerical values mentioned, unless otherwise specified or except when those numerical values obviously do not permit any other alternative in principle. Besides, the structures, steps, and the like that will be described in the following embodiments are not indispensable to this present disclosure, unless otherwise specified or except when those structures, steps, and the like obviously do not permit any other alternative in principle.

### 1. First Embodiment

1-1. Configuration Example of Remote Operating System

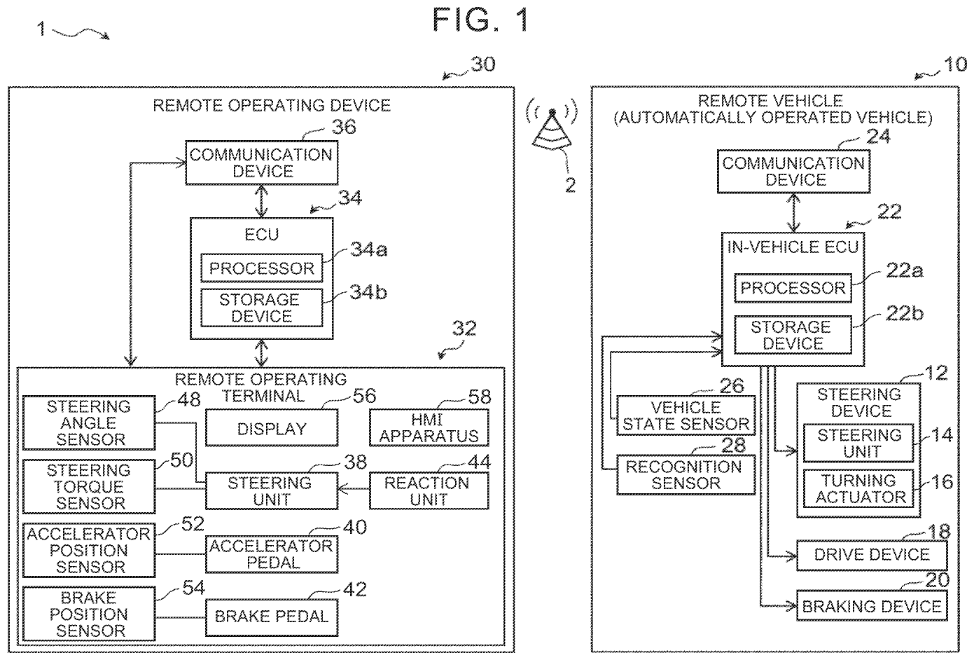

FIG. 1 is a block diagram showing a configuration example of a remote operating system 1 according to the first embodiment. The remote operating system 1 is equipped with a remote vehicle (hereinafter referred to simply as “the vehicle” as well) 10 to be subjected to remote manipulation, and a remote operating device 30 that remotely manipulates the remote vehicle 10.

1-1-1. Remote Vehicle (Automatically Operated Vehicle)

The vehicle 10 is equipped with a steering device 12, a drive device 18, a braking device 20, an in-vehicle electronic control unit (in-vehicle ECU) 22, a communication device 24, a vehicle state sensor 26, and a recognition sensor 28. The vehicle 10 is an automatically operated vehicle.

The steering device 12 has a steering unit 14 (the first steering unit), and turns wheels of the vehicle 10. The drive device 18 generates a driving force for the vehicle 10, and is, for example, an internal combustion engine. The braking device 20 generates a braking force for the vehicle 10. More specifically, for example, the steering device 12, the drive device 18, and the braking device 20 are all configured as by-wire-type devices. Therefore, the steering device 12 is equipped with a turning actuator 16 that is mechanically disconnected from the steering unit 14. The turning actuator 16 is configured as, for example, an electrically operated actuator, and turns the wheels. The drive device 18 is equipped with an electronically controlled throttle. Another example of the by-wire-type drive device 18 is an electric motor for causing the vehicle to run. The braking device 20 is an electronically controlled brake (ECB).

The in-vehicle ECU 22 is a computer that controls the vehicle 10. In concrete terms, the in-vehicle ECU 22 is equipped with a processor 22a (the first processor) and a storage device 22b. The processor 22a performs various processes. The storage device 22b stores various pieces of information. A volatile memory, a non-volatile memory, a hard disk drive (HDD), or a solid state drive (SSD) is exemplified as the storage device 22b. The various processes performed by the in-vehicle ECU 22 are realized through the execution of various computer programs by the in-vehicle ECU 22 (the processor 22a). The various programs are stored in the storage device 22b or recorded in a computer-readable recording medium. Incidentally, there may be a plurality of processors 22a and a plurality of storage devices 22b.

The communication device 24 (the first communication device) communicates with the remote operating device 30 via a wireless communication network 2. The vehicle state sensor 26 detects a state of the vehicle 10. A vehicle speed sensor (wheel speed sensor), a steering angle sensor, a yaw rate sensor, or a lateral acceleration sensor is exemplified as the vehicle state sensor 26. The recognition sensor 28 recognizes (detects) a situation around the vehicle 10. A camera, a laser imaging detection and ranging (lidar), or a radar is exemplified as the recognition sensor 28.

1-1-2. Remote Operating Device

The remote operating device 30 is equipped with a remote operating terminal 32, an electronic control unit (ECU) 34, and a communication device 36. The remote operating terminal 32 is equipped with a steering unit 38 (the second steering unit), an accelerator pedal 40, and a brake pedal 42 as remote manipulators that are manipulated by an operator for remote manipulation of the vehicle 10. Incidentally, instead of the example shown in FIG. 1, the remote operating terminal 32 may be equipped with only the steering unit 38, or one of the accelerator pedal 40 and the brake pedal 42 as well as the steering unit 38.

The remote operating terminal 32 is equipped with a reaction unit 44 that applies a manipulative reaction force to the steering unit 38. More specifically, with a view to ensuring that the operator who carries out remote manipulation can obtain a feeling of manipulation of the vehicle 10 via the steering unit 38, the reaction unit 44 is configured to apply a manipulative reaction force against the manipulation of the steering unit 38 by the operator. The remote operating terminal 32 may be equipped with similar reaction units for the accelerator pedal 40 and the brake pedal 42 respectively.

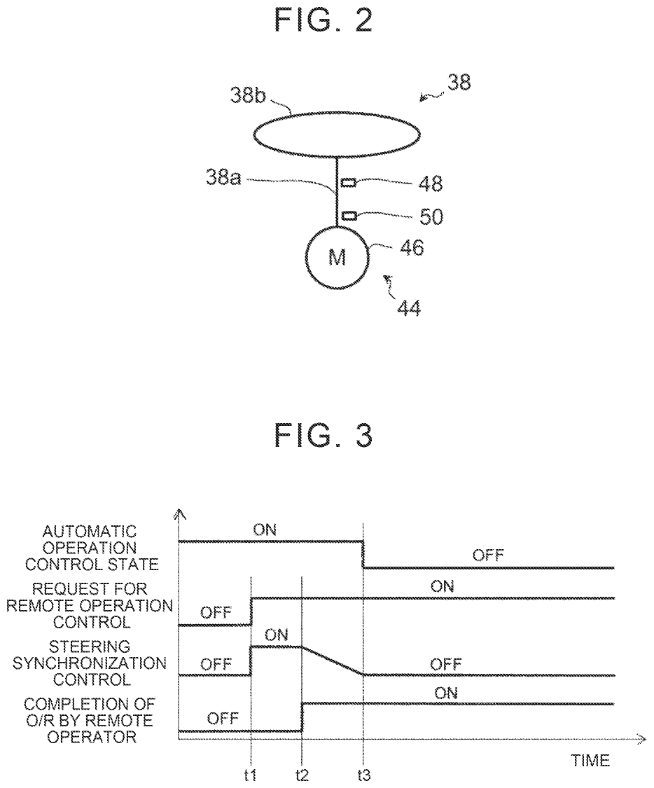

FIG. 2 is a view showing a concrete configuration example around the steering unit 38 shown in FIG. 1. As shown in FIG. 2, the reaction unit 44 of the steering unit 38 includes, for example, a reaction motor 46 that is coupled to a steering wheel 38b via a steering shaft 38a. The magnitude of the manipulative reaction force generated by the reaction motor 46 is controlled by the ECU 34. Therefore, the reaction unit 44 can freely change the manipulative reaction force (steering reaction force). Incidentally, the reaction motor 46 corresponds to an example of “the electric motor” according to the present disclosure.

Besides, the steering shaft 38a is provided with a steering angle sensor 48 and a steering torque sensor 50. The steering angle sensor 48 outputs a signal corresponding to a rotational angle of the steering wheel 38b, namely, a steering angle (actual steering angle) θr (a steering amount) to the ECU 34. The steering torque sensor 50 outputs a signal corresponding to the steering torque applied to the steering shaft 38a to the ECU 34. The accelerator pedal 40 is provided with an accelerator position sensor 52. The accelerator position sensor 52 outputs a signal corresponding to a depression amount (manipulation amount) of the accelerator pedal 40 to the ECU 34. The brake pedal 42 is provided with a brake position sensor 54. The brake position sensor 54 outputs a signal corresponding to a depression amount (manipulation amount) of the brake pedal 42 to the ECU 34. An output signal of the steering angle sensor 48 (as well as output signals of the accelerator position sensor 52 and the brake position sensor 54) is transmitted to the communication device 36 via the ECU 34.

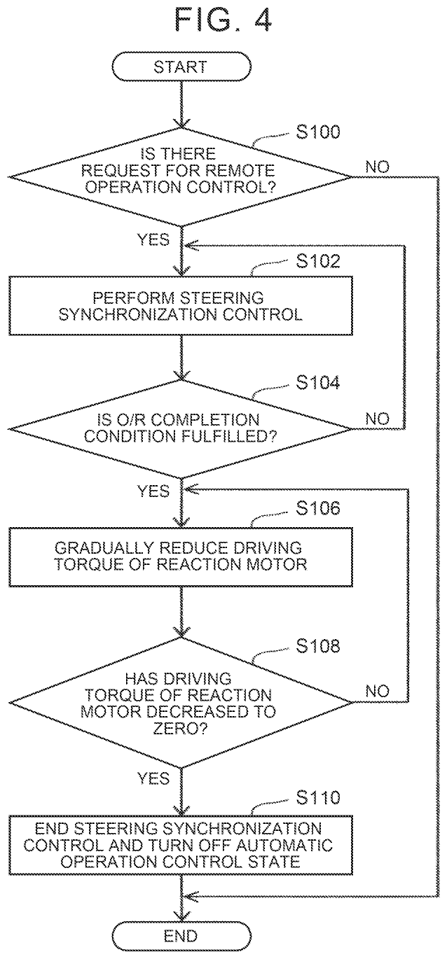

Besides, the remote operating terminal 32 is equipped with a display 56 used for remote manipulation by the operator. The display 56 displays, for example, an image around (at least in front of) the vehicle 10 that has been imaged by a camera (the recognition sensor 28) of the vehicle 10. Besides, the remote operating terminal 32 is equipped with a human machine interface (HMI) apparatus 58 such as a button. The HMI apparatus 58 is used when the operator makes various requests of the vehicle 10. The various requests mentioned herein include, for example, a request to start remote operation control that will be described later with reference to FIG. 4, and a request for steering assist through automatic operation control that will be described later with reference to FIG. 6.

The ECU 34 is a computer that performs a process regarding the remote operating device 30. In concrete terms, the ECU 34 is equipped with a processor 34a (the second processor) and a storage device 34b. The processor 34a performs various processes regarding remote manipulation of the vehicle 10 by the remote operating terminal 32. The storage device 34b stores various pieces of information. Concrete examples of the storage device 34b are similar to those of the storage device 22b. The various processes performed by the ECU 34 are realized through the execution of various computer programs by the ECU 34 (the processor 34a). The various computer programs are stored in the storage device 34b or recorded in a computer-readable recording medium. Incidentally, there may be a plurality of processors 34a and a plurality of storage devices 34b.

A plurality of remote operating terminals 32 may be connected to the ECU 34. That is, the ECU 34 may function as a server that manages the remote operating terminals 32.

The communication device 36 (the second communication device) communicates with the vehicle 10 via the wireless communication network 2. In concrete terms, when the remote operating device 30 remotely manipulates the vehicle 10, the communication device 36 transmits respective manipulation amounts detected by the sensors 48, 52, and 54 (the steering angle θr and the depression amounts of the accelerator pedal 40 and the brake pedal 42) to the vehicle 10. The in-vehicle ECU 22 controls the steering device 12 (the turning actuator 16), the drive device 18, and the braking device 20 based on the respective manipulation amounts from the remote operating device 30. Besides, the communication device 36 receives various data from the vehicle 10. The various data (various pieces of information) mentioned herein include image data in the camera displayed on the display 56, and data on “a target steering angle θvt” that will be described later.

1-2. Steering Control

The in-vehicle ECU 22 can perform “automatic operation control” of the vehicle 10 when the remote operating device 30 does not remotely manipulate the vehicle 10. On the other hand, the ECU 34 (the processor 34a) of the remote operating device 30 performs “remote operation control” for remotely manipulating the vehicle 10. Each of this automatic operation control and this remote operation control includes the control of the steering device 12, the drive device 18, and the braking device 20. It should be noted, however, that the following description will be given, focusing on the control of the steering device 12 (the turning actuator 16). Besides, steering control that will be described later includes the control of the steering unit 38 on the remote operating device 30 side (“steering synchronization control” that will be described later) as well as the control of the turning actuator 16.

During the performance of automatic operation control, the in-vehicle ECU 22 generates a target trajectory of the vehicle 10, and calculates a control amount of the turning actuator 16 for causing the vehicle 10 to follow the generated target trajectory. In concrete terms, the control amount includes the target steering angle θvt of the steering unit 14 of the vehicle 10. The in-vehicle ECU 22 calculates a target turning angle δt based on, for example, the target steering angle θvt and the vehicle speed. The in-vehicle ECU 22 then controls the turning actuator 16 such that an actual turning angle δ follows the target turning angle δt.

On the other hand, during the performance of remote operation control, the steering angle θr of the steering unit 38 manipulated by the operator is transmitted to the vehicle 10 via the communication device 36. During the performance of remote operation control, the received steering angle θr is used instead of the target steering angle θvt, so as to calculate the target turning angle δt. In concrete terms, the in-vehicle ECU 22, for example, calculates the target turning angle δt based on the steering angle θr and the vehicle speed, and controls the turning actuator 16 such that the actual turning angle δ follows the target turning angle δt.

FIG. 3 is a time chart for illustrating steering control at the time when remote operation overrides automatic operation. During the performance of automatic operation control, the manipulation of the steering device 12 through automatic operation control may be overridden (O/R) by the manipulation thereof through remote operation control.

In concrete terms, the operator may request remote operation after the lapse of a predetermined time from the present timing. A timing t1 in FIG. 3 corresponds to a timing when a request for the performance of remote operation (a request for remote operation control) is transmitted from the in-vehicle ECU 22 that performs automatic operation control to the ECU 34 on the remote operating device 30 side. This request for remote operation control is transmitted a predetermined time prior to a timing when the vehicle 10 is estimated to deviate from an operational design domain (ODD) for automatic operation, for example, when it is apparent that the vehicle 10 will deviate from the operational design domain ODD after the lapse of the predetermined time. This is because of the purpose of enabling smooth operational shift from automatic operation control to remote operation control. Incidentally, the request for remote operation control is held ON until the end of remote manipulation by the operator.

The ECU 34 that has received the request for remote operation control starts “steering synchronization control” that will be described below. Steering synchronization control is performed while automatic operation control lasts (in an automatic operation control state). In addition, the ECU 34 that has received the request for remote operation control swiftly decides who should remotely manipulate the vehicle 10 as the operator. For example, in the case where there are a plurality of candidates for the operator who remotely manipulates the vehicle 10, the ECU 34 allocates the operator most suited for remote operation of the vehicle 10 to the vehicle 10. Steering synchronization control may be started when the operator allocated to the vehicle 10 becomes able to start manipulating the remote operating terminal 32.

During the performance of steering synchronization control, the target steering angle θvt of the steering unit 14 on the vehicle 10 side for use in automatic operation control is transmitted from the communication device 24 on the vehicle 10 side to the remote operating device 30. The ECU 34 that has received the target steering angle θvt controls the reaction motor 46 in such a manner as to generate a driving torque for making the steering angle θr of the steering unit 38 on the remote operating device 30 side coincident with the target steering angle θvt. In other words, the ECU 34 controls the reaction motor 46 such that the steering unit 38 on the remote operating device 30 side makes a rotating motion at a motion amount synchronized with the target steering angle θvt that is a target value of automatic operation control in progress.

According to this steering synchronization control, the operator who starts remote manipulation of the vehicle 10 can feel how the vehicle 10 moves in accordance with the steering angle θr of the steering unit 38, by gripping the steering unit 38 that makes a rotating motion in accordance with the target steering angle θvt. In other words, the operator can cause the vehicle 10 to run in a familiar manner, through the use of the rotating motion of the steering unit 38 corresponding to the target steering angle θvt through automatic operation control.

Supplementary description of the steering angle θr of the steering unit 38 during the performance of steering synchronization control will now be given. During the performance of steering synchronization control, the turning angle δ of the wheels of the vehicle 10 changes in accordance with the steering angle θr of the steering unit 38. That is, the target steering angle θvt calculated by the in-vehicle ECU 22 for automatic operation control is transmitted to the remote operating device 30, instead of being directly designated by the steering device 12. The steering unit 38 is then rotationally driven by the reaction motor 46 such that the transmitted target steering angle θvt coincides with the steering angle θr of the steering unit 38. The steering angle θr of the steering unit 38 that is rotationally driven in this manner is detected by the steering angle sensor 48, and is transmitted to the vehicle 10. The steering device 12 (the turning actuator 16) is driven in such a manner as to realize the target turning angle δt corresponding to the transmitted steering angle θr.

Accordingly, if the operator does not apply any steering force to the steering unit 38, the steering angle θr that is transmitted from the remote operating device 30 to the vehicle 10 during the performance of steering synchronization control is equal to the target steering angle θvt. On the other hand, when the operator grips the steering unit 38 that is rotationally driven by the reaction motor 46, the steering force of the operator is applied to the steering unit 38. Therefore, the steering angle θr that is transmitted to the vehicle 10 can be different from the target steering angle θvt, depending on the manipulation by the operator.

A timing t2 in FIG. 3 corresponds to a timing when an override (O/R) completion condition is fulfilled. It is determined whether or not this O/R completion condition is fulfilled, so as to confirm that the operator can normally carry out remote manipulation of the vehicle 10. The O/R completion condition is fulfilled when a state where the steering force of the operator is applied to the steering unit 38 and a difference Δθ between the steering angle θr of the steering unit 38 and the target steering angle θvt is smaller than a predetermined threshold has lasted for a predetermined time.

In more concrete terms, when the operator grips the steering unit 38 that is rotationally driven by the reaction motor 46, the steering force of the operator is applied to the steering unit 38. It is therefore possible to detect that the operator applies the steering force (i.e., that the operator grips the steering unit 38). Then, during the performance of steering synchronization control, the reaction motor 46 applies, to the steering unit 38, a driving torque for making the target steering angle θvt that is continuously transmitted from the vehicle 10 coincident with the steering angle θr. Therefore, when the operator rotates the steering unit 38 in a rotational direction different from that of the rotating motion of the steering unit 38 by the reaction motor 46 for realizing the target steering angle θvt, and by a rotational amount different from that of this rotating motion, the difference Δθ between the target steering angle θvt and the steering angle θr increases. On the other hand, when the rotating motion of the steering unit 38 by the reaction motor 46 and the rotating motion by the operator are close to each other, the difference Δθ is small. Accordingly, it is possible to determine that the O/R completion condition is fulfilled when the state where the steering force of the operator is applied to the steering unit 38 and the difference Δθ is smaller than the threshold has lasted for the predetermined time. In other words, it is possible to determine that familiar running is completed at this time.

When the driving torque of the steering unit 38 by the reaction motor 46 for making the steering angle θr coincident with the target steering angle θvt remains unchanged after the arrival of the timing t2 when the O/R completion condition is fulfilled, this driving torque serves as a manipulative reaction force against the steering by the operator who has finished familiar running, and hinders the manipulation by the operator.

Thus, in the example shown in FIG. 3, the ECU 34 corrects the driving torque of the reaction motor 46 in steering synchronization control as follows, after the timing t2. That is, the ECU 34 controls the reaction motor 46 such that the driving torque decreases gradually. As a result, the manipulative reaction force resulting from the motion of the reaction motor 46 for making the steering angle θr coincident with the target steering angle θvt gradually decreases with the passage of time. The operator's feeling of manipulation can be kept from abruptly changing as a result of sudden disappearance of the manipulative reaction force, by gradually reducing the driving force after the fulfillment of the O/R completion condition in this manner.

A timing t3 corresponds to a timing when the driving torque has decreased to zero. Upon arrival of the timing t3, the state of automatic operation control is turned OFF. As a result, the in-vehicle ECU 22 stops calculating the target steering angle θvt, and the calculated target steering angle θvt is stopped from being transmitted to the remote operating device 30.

The aforementioned steering synchronization control corresponds to an example of steering control that is performed during the execution of “the cooperative mode in which the turning actuator is controlled through cooperation between remote operation control for controlling the turning actuator based on the steering angle of the second steering unit steered by the operator and the automatic operation control” according to the present disclosure. As in the example of the aforementioned steering synchronization control, the cooperative mode is executed by the remote operating system 1 (more specifically, the ECU 34 and the in-vehicle ECU 22 that are in cooperative motion).

FIG. 4 is a flowchart showing an example of the flow of a process regarding steering control according to the first embodiment. The process of this flowchart is performed by the remote operating system 1.

In FIG. 4, first of all in step S100, the ECU 34 (the processor 34a) on the remote operating device 30 side determines whether or not the aforementioned request for remote operation control has been made. The result of this determination is positive when the ECU 34 receives the request for remote operation control from the vehicle 10 via the communication device 36, for example, as described with reference to FIG. 3. Besides, the result of the present determination is also positive when, for example, the operator voluntarily makes a request for the start of remote operation control (a request for override by remote operation) of the vehicle 10 by manipulating the HMI apparatus 58.

In step S100, when there is no request for remote operation control, the ECU 34 ends the current process. On the other hand, when there is a request for remote operation control, the process proceeds to step S102.

In step S102, the remote operating system 1 (more specifically, the ECU 34 and the in-vehicle ECU 22 that are in cooperative motion) performs the aforementioned steering synchronization control. That is, the in-vehicle ECU 22 (the processor 22a) calculates the target steering angle θvt according to automatic operation control, and transmits the calculated target steering angle θvt to the remote operating device 30 via the communication device 24. The ECU 34 that has received the target steering angle θvt controls the reaction motor 46 in such a manner as to generate the driving force for making the steering angle θr of the steering unit 38 coincident with the target steering angle θvt. The ECU 34 detects the steering angle θr of the steering unit 38 that is steered by the operator while being driven by the reaction motor 46, through the use of the steering angle sensor 48. The ECU 34 then transmits the detected steering angle θr to the vehicle 10 through the use of the communication device 36. The in-vehicle ECU 22 controls the turning actuator 16 such that the target turning angle δt corresponding to the received steering angle θr is obtained. Incidentally, the steering angle θr detected through the use of the steering angle sensor 48 may be transmitted to the vehicle 10 by the communication device 36, without the intermediary of the ECU 34.

In step S104 following step S102, the ECU 34 determines whether or not the aforementioned O/R completion condition is fulfilled. As a result, as long as the O/R completion condition is not fulfilled, steering synchronization control is continued. On the other hand, if the O/R completion condition is fulfilled, the process proceeds to step S106.

In step S106, the ECU 34 gradually reduces the driving force of the steering unit 38 applied by the reaction motor 46 for making the steering angle θr coincident with the target steering angle θvt. In step S108 following step S106, the ECU 34 determines whether or not the driving torque has decreased to zero. As a result, if the driving torque has decreased to zero, the process proceeds to step S110, steering synchronization control is (completely) ended, and the state of automatic operation control is turned OFF.

1-3. Effects

With the remote operating system 1 according to the first embodiment described above, the reaction motor 46 is controlled in such a manner as to generate the driving torque for making the steering angle θr of the steering unit 38 on the remote operating device 30 side coincident with the target steering angle θvt of the steering unit 14 on the vehicle 10 side according to automatic operation control, during the execution of the cooperative mode of remote operation control and automatic operation control (steering synchronization control). Since the target steering angle θvt is used, the steering unit 38 does not synchronize with the actual steering angle θv of the steering unit 14 that vibrates due to road surface disturbance. Therefore, the operator who carries out remote manipulation can grasp the steering angle θv of the steering unit 14 on the vehicle 10 side according to automatic operation control during the execution of the cooperative mode, without being affected by vibrations resulting from road surface disturbance.

More specifically, according to the first embodiment, “the cooperative mode” that is accompanied by the performance of steering synchronization control is executed when the manipulation of the steering device 12 (the turning actuator 16) through automatic operation control is overridden by the manipulation through remote operation control. Thus, at the beginning of remote operation control, the steering angle θr of the steering unit 38 and the turning angle δ on the vehicle 10 side can be synchronized with each other. Then, through the use of the target steering angle θvt in the case where override is thus carried out, the operator can smoothly start manipulating the steering unit 38 without being affected by the foregoing vibrations. Besides, by gripping the steering unit 38 that is driven by the reaction motor 46 such that the steering angle θr coincides with the target steering angle θvt, the operator can cause the vehicle to run in a familiar manner, through the use of an input to the steering unit 38 from automatic operation control at the beginning of remote manipulation. In other words, the remote operating system 1 can assist the operator in causing the vehicle to ruin in a familiar manner.

1-4. Another Example of Motion after Fulfilment of O/R Completion Condition

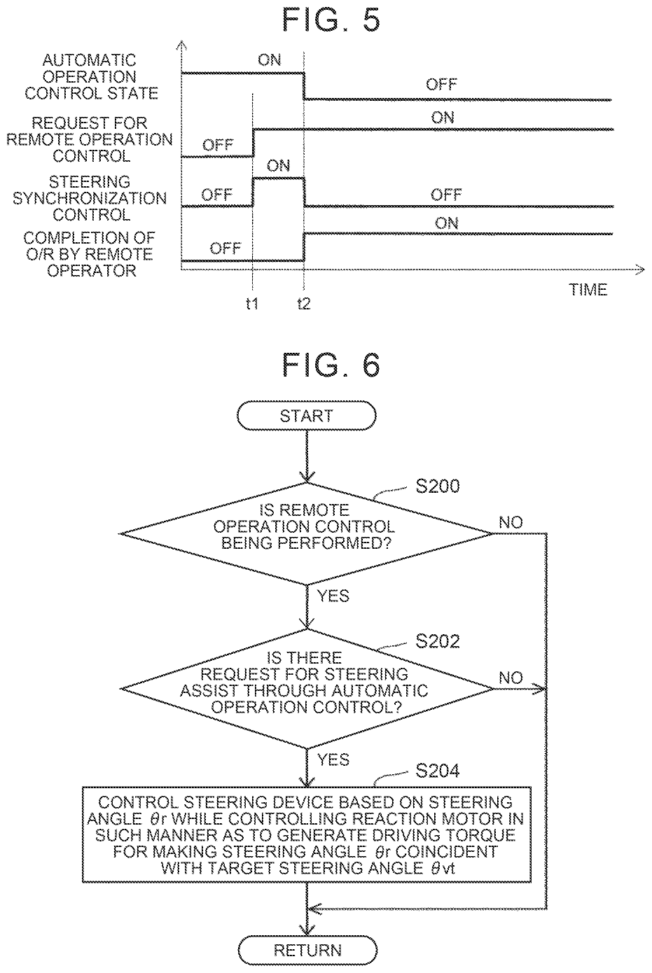

FIG. 5 is a time chart for illustrating another example of steering control at the time when remote operation overrides automatic operation. In the foregoing example shown in FIG. 3, the process of gradually reducing the driving torque of the steering unit 38 applied by the reaction motor 46 to zero is performed after the fulfillment of the O/R completion condition at the timing t2. In contrast, in an example shown in FIG. 5, such a process is not performed, and the driving torque is made equal to zero at the timing t2. That is, in this example, steering synchronization control is completely ended at the timing t2. Then, as a result, the state of automatic operation control is turned OFF at the timing t2. Steering synchronization control may be performed in this manner. In addition, the example shown in FIG. 5 corresponds to an example according to the present disclosure in which “the cooperative mode” is ended upon fulfillment of the O/R completion condition.

1-5. Another Example of Cooperative Mode

“The cooperative mode” according to the present disclosure may be executed not only when the control of the steering device 12 through automatic operation control is overridden by remote operation control as described in the first embodiment, but also in, for example, the following case. That is, the cooperative mode may be executed, for example, when steering assist of the vehicle 10 through automatic operation control is carried out during the performance of remote operation control.

FIG. 6 is a flowchart showing an example of the flow of a process regarding another example of the cooperative mode according to the present disclosure. The process of this flowchart is performed by the remote operating system 1 (the in-vehicle ECU 22 and the ECU 34).

In FIG. 6, first of all, the ECU 34 (the processor 34a) on the remote operating device 30 side determines in step S200 whether or not remote operation control is being performed. As a result, if remote operation control is not being performed, the ECU 34 ends the current process.

On the other hand, if remote operation control is being performed in step S200, the process proceeds to step S202. In step S202, the ECU 34 determines whether or not there is a request for steering assist through automatic operation control. This request for steering assist is issued by, for example, the operator who manipulates the HMI apparatus 58. The request for steering assist is transmitted to the ECU 34, and is transmitted to the in-vehicle ECU 22 via the communication device 36.

If there is no request for steering assist in step S202, the ECU 34 ends the current process. On the other hand, if there is a request for steering assist, the process proceeds to step S204. In step S204, for the sake of steering assist through automatic operation control, the remote operating system 1 (more specifically, the ECU 34 and the in-vehicle ECU 22 that are in cooperative motion) controls the steering device 12 based on the steering angle θr detected by the steering angle sensor 48, while controlling the reaction motor 46 in such a manner as to generate the driving torque for making the steering angle θr of the steering unit 38 coincident with the target steering angle θvt.

In more concrete terms, in step S204, the in-vehicle ECU 22 (the processor 22a) calculates the target steering angle θvt according to automatic operation control, and transmits the calculated target steering angle θvt to the remote operating device 30 via the communication device 24, as during the performance of the aforementioned steering synchronization control. The ECU 34 that has received the target steering angle θvt controls the reaction motor 46 in such a manner as to generate the driving torque for making the steering angle θr of the steering unit 38 coincident with the target steering angle θvt. The ECU 34 detects the steering angle θr of the steering unit 38 that is steered by the operator while being driven by the reaction motor 46, through the use of the steering angle sensor 48. The ECU 34 then transmits the detected steering angle θr to the vehicle 10 via the communication device 36. The in-vehicle ECU 22 controls the turning actuator 16 such that the target turning angle δt corresponding to the received steering angle θr is obtained.

As described above, according to this example of cooperative mode, steering assist through automatic operation control is provided by controlling the reaction motor 46 in such a manner as to generate the driving torque for making the steering angle θr of the steering unit 38 coincident with the target steering angle θvt, when there is a request for steering assist during the performance of remote operation control. Moreover, the target steering angle θvt is used in this example as well. Therefore, the operator who carries out remote manipulation can grasp the steering angle θv of the steering unit 14 on the vehicle 10 side according to automatic operation control during the execution of the cooperative mode (steering assist through the use of automatic operation control), without being affected by vibrations resulting from road surface disturbance.

### 2. Second Embodiment

In the second embodiment, steering control at the beginning of remote operation control in the case where an abnormality occurs in the vehicle 10 during the performance of automatic operation control will be described. Steering control that will be described below is performed in combination with steering control (including steering synchronization control) of the first embodiment.

In the vehicle 10 as the automatically operated vehicle, an abnormality may occur in calculation of the target steering angle θvt by the in-vehicle ECU 22 (the processor 22a). More specifically, this abnormality is a decrease in reliability (in other words, credibility) of the calculated target steering angle θvt. An automatic operating system (e.g., including the in-vehicle ECU 22 having the processors 22a) configured in the vehicle 10 functions such that, for example, the processors 22a mutually monitor if the foregoing abnormality has occurred. Then, basically, the in-vehicle ECU 22 swiftly stops the vehicle 10 from running, when it is determined that the abnormality has occurred.

Even when the vehicle 10 is stopped in response to the foregoing determination that the abnormality has occurred, it is necessary to override the operation of the vehicle 10 by remote operation control. Therefore, the in-vehicle ECU 22 that has determined that the abnormality has occurred transmits a request for remote operation control to the remote operating device 30 via the communication device 24. It should be noted herein that if the actual steering angle θv of the stopped vehicle 10 and the steering angle θr of the steering unit 38 on the remote operating device 30 side do not coincide with each other when the remote operating device 30 that has received this request for remote operation control starts remote operation control, an inconvenience may be caused at the early stage of remote manipulation.

Thus, in the present embodiment, if the foregoing abnormality has not occurred (if everything is in order) in overriding the manipulation of the steering device 12 through automatic operation control by the manipulation through remote operation control, the target steering angle θvt is used as described in the first embodiment (e.g., see FIG. 4 or 6). On the other hand, in the case where this override is carried out when the foregoing abnormality occurs, the actual steering angle θv is used. In concrete terms, the ECU 34 controls the reaction motor 46 such that the steering angle θr of the steering unit 38 coincides with the actual steering angle θv of the steering unit 14 of the vehicle 10.

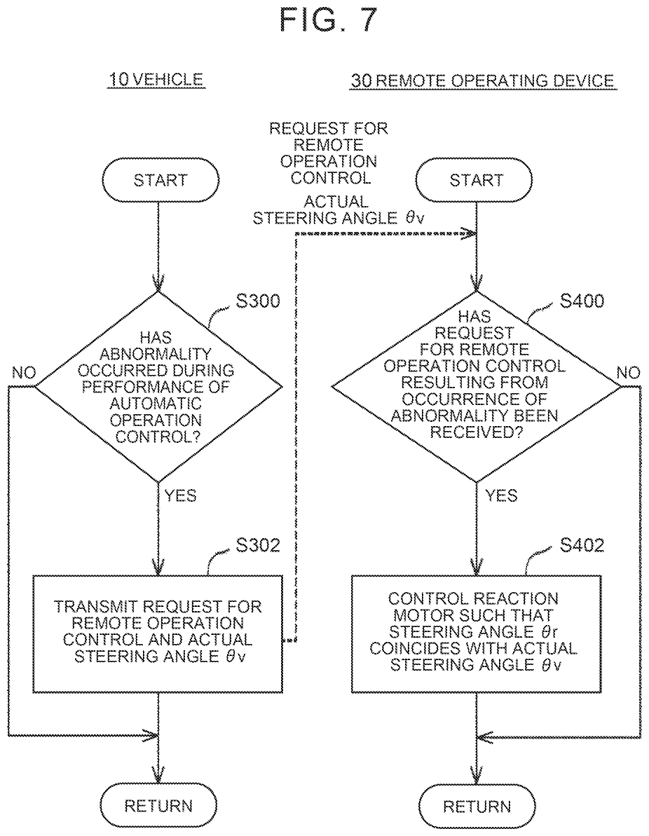

FIG. 7 is a flowchart showing an example of the flow of a process regarding steering control at the time of the occurrence of an abnormality according to the second embodiment. The process of this flowchart is performed during the performance of automatic operation control.

First of all, the process on the vehicle 10 side will be described. In step S300, the processor 22a of the in-vehicle ECU 22 determines whether or not the foregoing abnormality regarding calculation of the target steering angle θvt has occurred during the performance of automatic operation control. As a result, if the abnormality has not occurred, the in-vehicle ECU 22 ends the current process. On the other hand, if the abnormality has occurred, the process proceeds to step S302.

In step S302, the in-vehicle ECU 22 transmits information indicating a request for remote operation control and information on the actual steering angle θv of the steering unit 14 to the remote operating device 30 through the use of the communication device 24.

Next, the process on the remote operating device 30 side will be described. In step S400, the ECU 34 (the processor 34a) determines whether or not a request for remote operation control resulting from the occurrence of an abnormality to be determined in step S300 has been received. As a result, if the request for remote operation control has not been received, the ECU 34 ends the current process. On the other hand, if the request for remote operation control has been received, the process proceeds to step S402.

In step S402, the ECU 34 controls the reaction motor 46 such that the steering angle θr of the steering unit 38 coincides with the actual steering angle θv of the steering unit 14 of the vehicle 10, in starting remote operation control. In addition, the reaction motor 46 may thus be controlled not only when the vehicle 10 is stopped in response to the occurrence of the foregoing abnormality, but also for, for example, the vehicle 10 that is not stopped after the occurrence of the foregoing abnormality.

According to the second embodiment described above, even in the case where the steering angle θr does not coincide with the actual steering angle θv when remote operation control is requested in response to the occurrence of an abnormality on calculation of the target steering angle θvt, remote operation control can be started with the steering angle θr and the actual steering angle θv coincident with each other.

Incidentally, in each of the foregoing first and second embodiments, the control (e.g., the aforementioned steering synchronization control) of the electric motor that generates the driving torque for making the manipulation amount of a remote manipulator coincident with the actual manipulation amount of a manipulator of the vehicle according to automatic operation control during the execution of the cooperative mode has been described, citing the steering unit 38 of the remote operating device 30 (the remote operating terminal 32) as an example. This control may be performed in a similar manner for the accelerator pedal that is another example of the remote manipulator, on the condition that the remote manipulator be equipped with an electric motor that drives the accelerator pedal. Besides, this control may be performed in a similar manner for the brake pedal that is another example of the remote manipulator, on the condition that the remote manipulator be equipped with an electric motor that drives the brake pedal.

What is claimed is:

1. A remote operating system comprising:
an automatically operated vehicle; and
a remote operating device that remotely manipulates the automatically operated vehicle, wherein
the automatically operated vehicle includes a steering device including a first steering unit and a turning actuator that turns a wheel of the automatically operated vehicle, a first processor that performs automatic operation control and that calculates a target steering angle of the first steering unit during performance of the automatic operation control, and a first communication device that transmits the target steering angle to the remote operating device,
the remote operating device includes a second steering unit that is manipulated by an operator for remote manipulation of the steering device, an electric motor that rotationally drives the second steering unit, a second communication device that receives the target steering angle from the first communication device and that transmits a steering angle of the second steering unit to the first communication device, and a second processor that controls the electric motor in such a manner as to generate a driving torque for making the steering angle of the second steering unit coincident with the target steering angle, during execution of a cooperative mode in which the turning actuator is controlled through cooperation between remote operation control for controlling the turning actuator based on the steering angle of the second steering unit steered by the operator and the automatic operation control, and
the turning actuator is controlled based on the steering angle of the second steering unit that is transmitted from the second communication device, during execution of the cooperative mode.

2. The remote operating system according to claim 1, wherein
the cooperative mode is executed when manipulation of the steering device through the automatic operation control is overridden by manipulation through the remote operation control.

3. The remote operating system according to claim 2, wherein
the cooperative mode is ended when an override completion condition is fulfilled, and
the override completion condition is fulfilled when a state where a steering force exerted by the operator is applied to the second steering unit and a difference between the steering angle of the second steering unit and the target steering angle is smaller than a threshold has lasted for a predetermined time.

4. The remote operating system according to claim 2, wherein
the second processor controls the electric motor such that the driving torque gradually decreases, after fulfillment of an override completion condition that is fulfilled when a state where a steering force exerted by the operator is applied to the second steering unit and a difference between the steering angle of the second steering unit and the target steering angle is smaller than a threshold has lasted for a predetermined time.

5. The remote operating system according to claim 1, wherein
the cooperative mode is executed when steering assist of the automatically operated vehicle through the automatic operation control is carried out during performance of the remote operation control.

6. The remote operating system according to claim 1, wherein
the second processor controls the electric motor such that the steering angle of the second steering unit coincides with an actual steering angle of the first steering unit, in a case where manipulation of the steering device through the automatic operation control is overridden by the remote operation control when an abnormality occurs in calculation of the target steering angle by the first processor.

7. A remote operating method for remotely manipulating an automatically operated vehicle by a remote operating device, wherein
the automatically operated vehicle includes a steering device including a first steering unit and a turning actuator that turns a wheel of the automatically operated vehicle, and
the remote operating device includes a second steering unit that is manipulated by an operator for remote manipulation of the steering device, and an electric motor that rotationally drives the second steering unit,
the remote operating method comprising:
calculating a target steering angle of the first steering unit during performance of automatic operation control of the automatically operated vehicle,
controlling the electric motor in such a manner as to generate a driving torque for making the steering angle of the second steering unit coincident with the target steering angle, during execution of a cooperative mode in which the turning actuator is controlled through cooperation between remote operation control for controlling the turning actuator based on the steering angle of the second steering unit steered by the operator and the automatic operation control, and
controlling the turning actuator based on the steering angle of the second steering unit that is transmitted from the remote operating device to the automatically operated vehicle, during execution of the cooperative mode.
